(19) United States
(12) Patent Application Publication
(10) Pub. No.: US 2022/0177281 A1
(43) Pub. Date: Jun. 9, 2022

(54) Apparatus for Lifting Heavy Loads

(71) Applicant: Mammoet Holding B.V., Utrecht (NL)

(72) Inventor: Wessel Helmens, Utrecht (NL)

(21) Appl. No.: 17/684,021

(22) Filed: Mar. 1, 2022

Related U.S. Application Data
(63) Continuation-in-part of application No. 15/716,233, filed on Sep. 26, 2017.

(30) Foreign Application Priority Data
Sep. 29, 2016 (NL) 2017553

(51) Int. Cl. B66C 23/34; B66C 23/82

(52) U.S. Cl. CPC B66C 23/34; B66C 2700/03; B66C 23/82

(57) ABSTRACT

A system for lifting heavy loads, that includes an apparatus having at least one mast or part of such mast, from which a load may be suspended and a removable erection facility external of the apparatus and disposed on a base on the ground, which erection facility includes an assembly frame having a push-up and lowering capability for the at least one mast or part of such mast, which erection facility is equipped to receive during erection of the apparatus or to remove during dismantling of the apparatus, a mast piece or a series of mast pieces below an assembly of mast pieces above said mast piece or series of mast pieces for converting the apparatus between a dismantled position and a fully erected position, at least that portion of the erection facility having the push-up and lowering capability being removable away from the apparatus and base after erection of the apparatus.

### CROSS-REFERENCE TO RELATED APPLICATIONS

This application is a continuation-in-part application of U.S. patent application Ser. No. 15/716,233, filed on Sep. 26, 2017, which itself claims priority to Netherlands Patent Application No. 2017553, filed on Sep. 29, 2016, and the specifications and claims thereof are incorporated herein by reference.

### STATEMENT REGARDING FEDERALLY SPONSORED RESEARCH OR DEVELOPMENT

Not Applicable.

### THE NAMES OF PARTIES TO A JOINT RESEARCH AGREEMENT

Not Applicable.

### INCORPORATION BY REFERENCE OF MATERIAL SUBMITTED ON A COMPACT DISC

Not Applicable.

### STATEMENT REGARDING PRIOR DISCLOSURES BY THE INVENTOR OR A JOINT INVENTOR

Not Applicable.

### COPYRIGHTED MATERIAL

Not Applicable.

### BACKGROUND OF THE INVENTION

Embodiments of the invention relate to an assembly and disassembly method of an apparatus for lifting heavy loads, comprising at least one mast or part of such mast, from which a load may be suspended.

An example of such a method and apparatus is provided by U.S. Pat. No. 6,279,764 which discloses a hoisting device which is assembled from components or elements, the largest of which has dimensions which do not exceed those of a standardized sea container. Accordingly, the hoisting device can be transported easily and at low cost, and requires a short time to assemble it at the location of the hoisting job, irrespective of the required hoisting height and load weight.

WO2016/133389 discloses however that there are still disadvantages with the partitioning of the hoisting device in components or elements with dimensions so that the device can be transported in standard sea containers. One problem is that its construction on-site requires a lot of space, because the masts and main boom have to be assembled on the ground to their full-length. WO2016/133389 suggest a solution for this problem by a stepwise raising of the respective masts with separate mast segments or pieces. In the method known from WO2016/133389 a back mast topslide is applied that is movable along the back mast, and which can preferably be fixed in position in a plurality of positions along the back mast. The method involves providing a back mast upper section, multiple back mast intermediate sections, and a back mast lower section, and requires the step of connecting a part of the back mast including at least the backrest upper section, and possibly one or more pre-connected intermediate sections, to the back mast topslide. The part of the back mast that has been connected to the back mast topslide is stepwise extended by attaching further back mast intermediate sections. During the extension of the back mast the back mast topslide is stepwise raised.

### BRIEF SUMMARY OF THE INVENTION

The system and method of the invention is provided with the features of one or more of the appended claims.

Further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more embodiments of the invention and are not to be construed as limiting the invention. In the drawings:

FIGS. 1, 2, 3, 4, 5, 6, 7, 8A, 8B, 9, 10, and 11 show consecutively a series of steps for erecting an apparatus according to the invention, wherein the apparatus is embodied as a crane; and

FIGS. 12, 13, 14, 15, 16, 17, 18, and 19 show consecutively a series of steps for erecting an apparatus according to the invention, wherein the apparatus is embodied as a gantry.

### DETAILED DESCRIPTION OF THE INVENTION

In a first aspect of the invention the system for lifting heavy loads, comprising: an apparatus comprising at least one mast or part of such mast, from which a load may be suspended; and a removable erection facility external of the apparatus and disposed on a base on the ground, which erection facility comprises an assembly frame comprising a push-up and lowering capability for the at least one mast or part of such mast, which erection facility is equipped to receive during erection of the apparatus or to remove during dismantling of the apparatus, a mast piece or a series of mast pieces below an assembly of mast pieces above said mast piece or series of mast pieces for converting the apparatus between a dismantled position and a fully erected position, wherein at least that portion of erection facility comprising the push-up and lowering capability is removable away from the apparatus and base after erection of the apparatus.

Placement and operation of the erection facility on the base resting on the ground makes handling easy. At base level it is easier to supply mast pieces to the erection facility and to remove mast pieces from the erection facility for converting the apparatus between a dismantled position and a fully erected position. Adding or removing a mast piece from the mast with the erection facility is thus entirely executable at base level and avoids the need to use ancillary equipment on the ground or elsewhere, such as other cranes to hoist the mast piece to its eventually intended level.

Another advantage is that the erection facility can be a general-purpose device so that the apparatus may be of any type and need not necessarily be a crane. The versatility that this provides will be further exemplified hereinafter.

The feature that the erection facility comprises an assembly frame that is provided with a push-up and lowering capability for the at least one mast or part of such mast supports that no further ancillary equipment is required on the ground or elsewhere to assemble or to disassemble the apparatus. Accordingly, the footprint of the system comprising the apparatus for hoisting heavy loads, and the erection facility for the assembly or disassembly of such apparatus is limited to the bare minimum.

The manner of implementation of the push-up and lowering capability of the erection facility is clear to the skilled person. Reference can for instance be made to Dutch patent 1 037 817, the content of which is deemed incorporated herein by reference, and which discloses a push-up and lowering device for heavy loads. Pushing and lowering with this known device is done with jacks. The loads as applied in this document may suitably be replaced by the masts as applied in the instant invention.

Another preferable feature of the invention to promote the ease of assembly or disassembly of the apparatus is that the at least one mast is construed as an assembly of mast pieces that are mountable to each other and dismountable from each other in a head to tail configuration.

As already mentioned, the apparatus of the invention is of tremendous versatility which can be exemplified with reference to embodiments wherein the apparatus comprises two masts or parts thereof.

In one implementation wherein two masts are applied the two masts can be embodied as gantry towers. In another implementation wherein two masts are applied the two masts can be embodied as a main boom and a back mast of a crane. Beneficial features of this crane implemented according to the invention are:
Boom length of back mast and main boom is adjustable in operational mode (unloaded)
Length of the back mast and main boom can be changed, without bringing the boom down to ground level.
Pivot point of the back mast and the main boom are far apart and have their own crawler or load spreader set. In this way the loadbearing pressure is relatively low.
In unfavorable environmental conditions it is not necessary to lower the main boom to ground level. The masts can be decreased in height, to a height that can withstand the extreme conditions.
Lifting of loads can be done with strand jacks or with winches.

The invention will hereinafter be further elucidated with reference to the drawing of two exemplary embodiments of an apparatus according to the invention that is not limiting as to the appended claims. Whenever in the figures the same reference numerals are applied, these numerals refer to the same or similar parts.

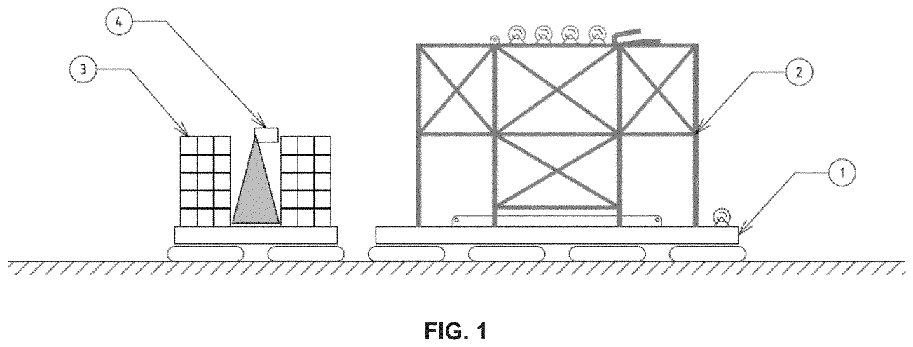

In FIG. 1 an initial position of some basic parts of a system of the invention are shown that are used for assembling the apparatus for hoisting heavy loads from the ground up. FIG. 1 shows base frame 1 on which assembly frame 2 is mounted. The assembly frame 2 constitutes the erection facility that is employed for the assembly or disassembly of the apparatus for hoisting heavy loads.

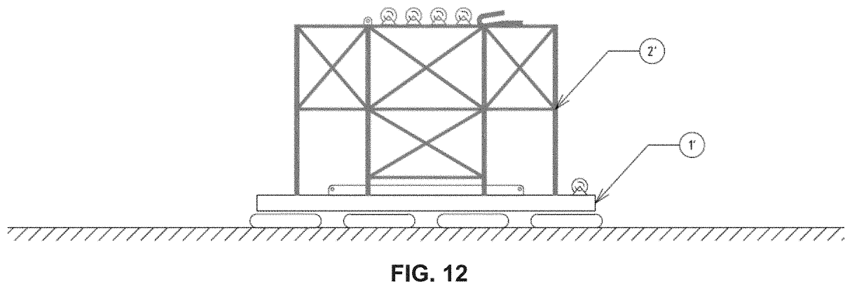

Next to base 1 with assembly frame 2, is counterweight 3 which is, like base 1, standing on the ground. Counterweight 3 is applied since this example relates to the assembly of a crane. After completing the discussion of this example, another example will be elucidated in which the counterweight is not present, and the apparatus will be construed as a gantry. This will be shown with reference to FIGS. 12-17.

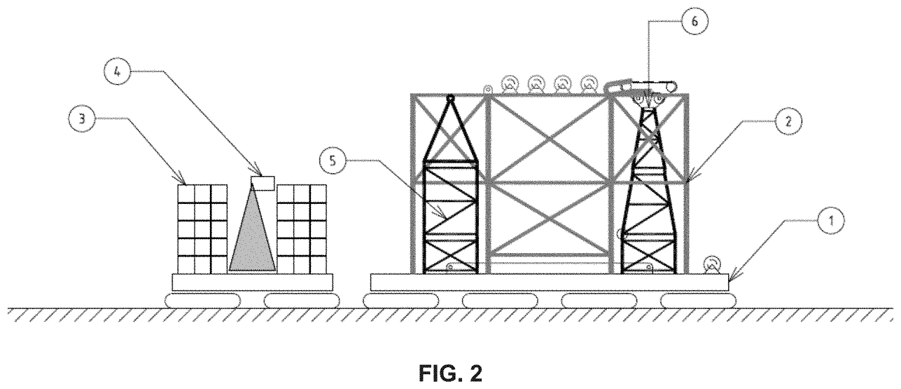

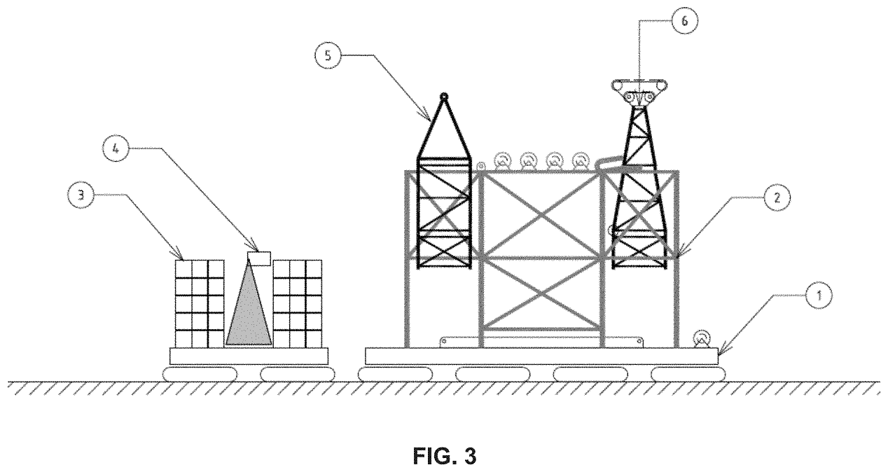

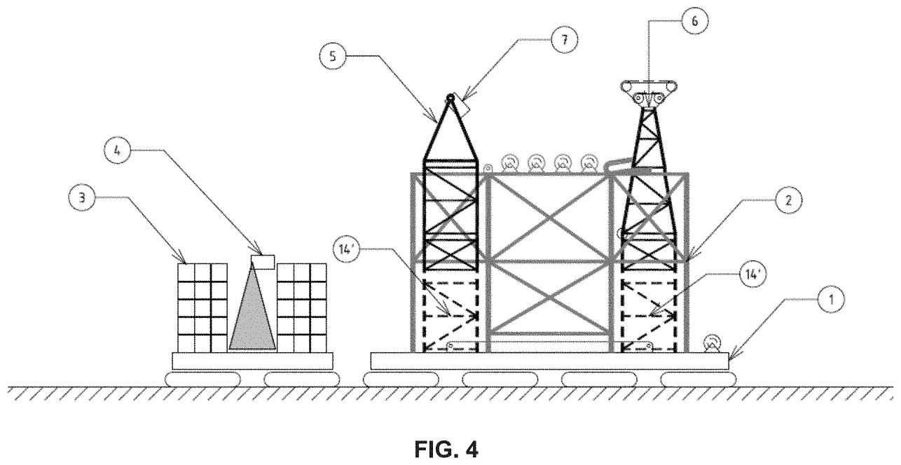

Turning now to FIG. 2 a next step in the assembly of the apparatus for hoisting heavy loads of the invention is shown that follows the initial situation of FIG. 1, being the placement in assembly frame 2 of the top parts of back mast 5 and main boom 6 respectively. In FIG. 3 it is shown that these top parts of back mast 5 and main boom 6 are lifted by assembly frame 2 to a higher level to provide room thereunder for receiving further pieces of back mast 5 and main boom 6 respectively that have to be assembled together with the already present parts. This is shown in FIG. 4 wherein the newly supplied pieces to assembly frame 2 are indicated with reference 14′.

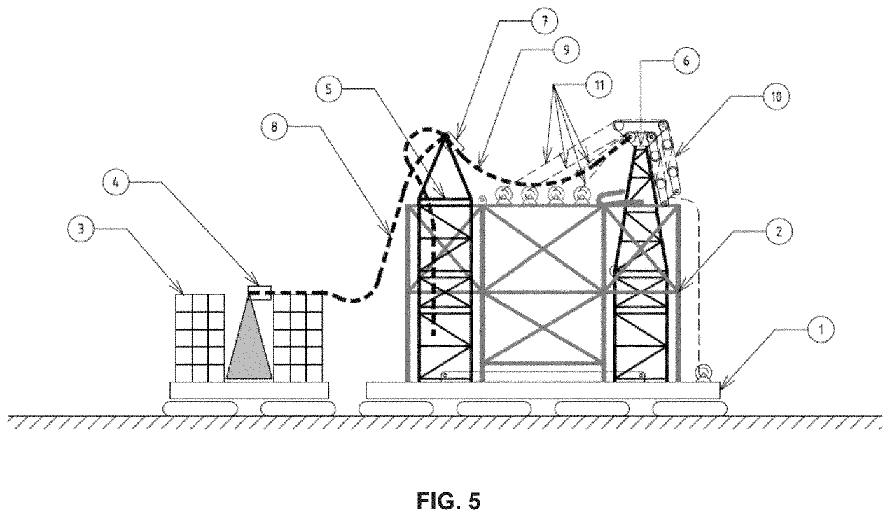

For sake of illustration FIG. 5 shows that the crane that is being assembled is also completed with several pieces of hoisting equipment, such as counterweight hoist line 8, main boom hoist line 9, lifting hoist 10, and lifting hoist lines 11.

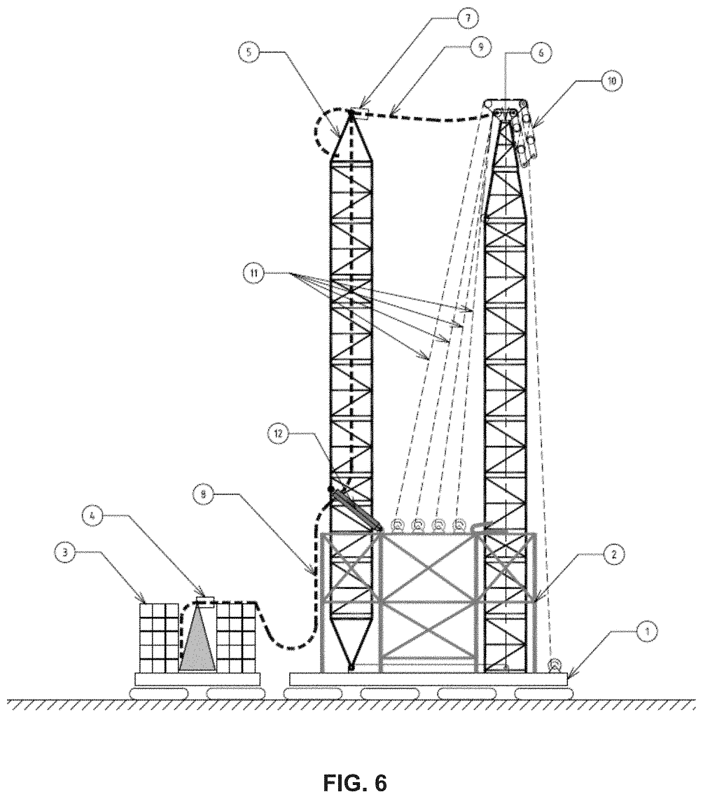

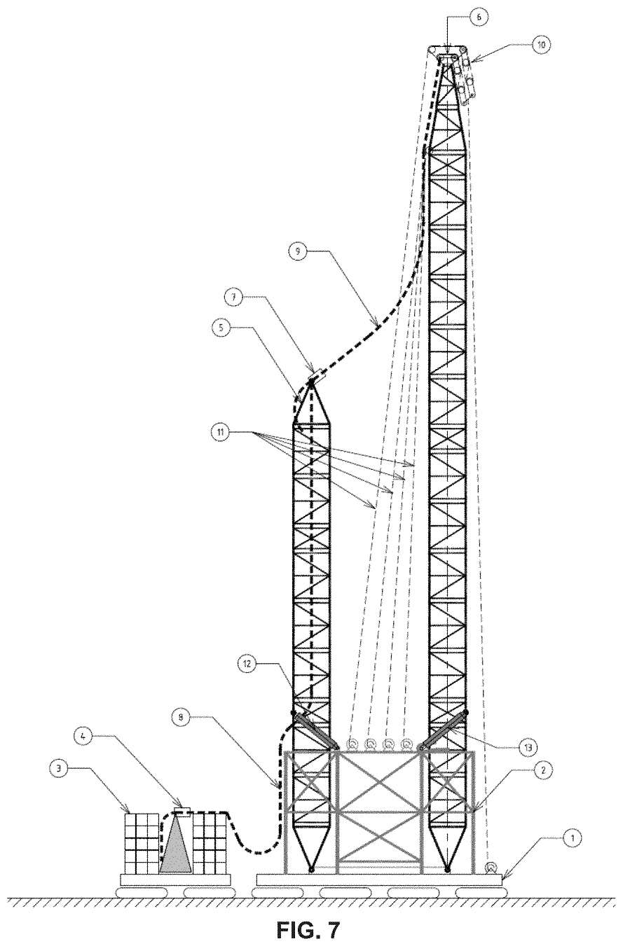

After the introduction of newly supplied pieces 14′ to assembly frame 2 as shown in FIG. 4, these pieces are preferably connected to and assembled together with the mast pieces above. After the so far assembled back mast 5 and main boom 6 can be lifted again by assembly frame 2 to make room for receiving further pieces of back mast 5 and main boom 6 respectively. This process can be continued until back mast 5 arrives at its completion as shown in FIG. 6. Following the completion of back mast 5 only main boom 6 is further elevated and completed by adding the still missing mast pieces, which are connected to and assembled together with the then lower end of main boom 6 in assembly frame 2, in the same way as discussed above until it reaches its completion as shown in FIG. 7. FIG. 7 further depicts that both back mast 5 and main boom 6 are supported only by base frame 1, whereas the function of erection facility or assembly frame 2 has been completed and is not required or used for further supporting back mast 5 and main boom 6. When the situation represented by FIG. 7 has been reached, the positioning of the respective parts of the crane can be accomplished.

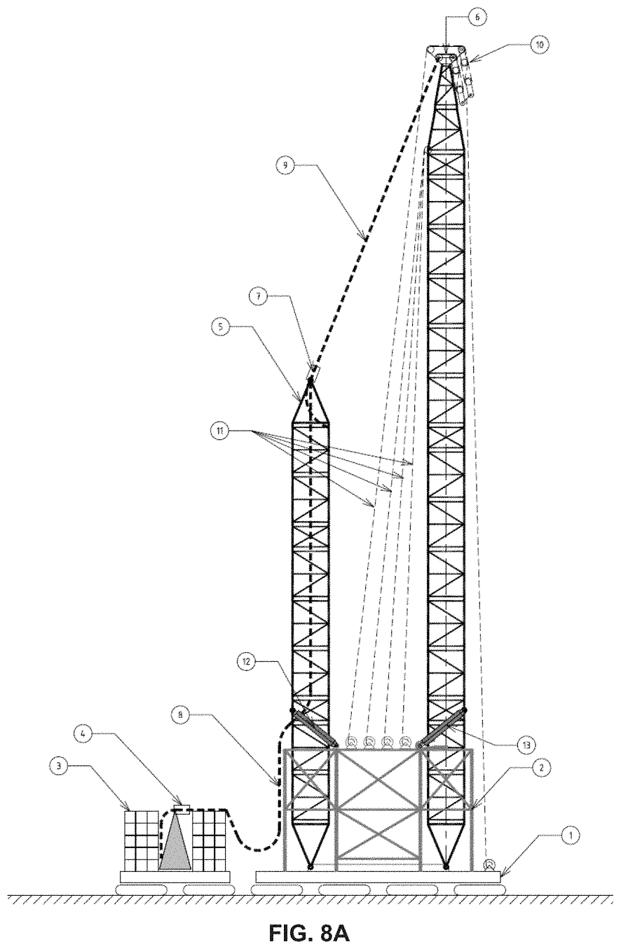

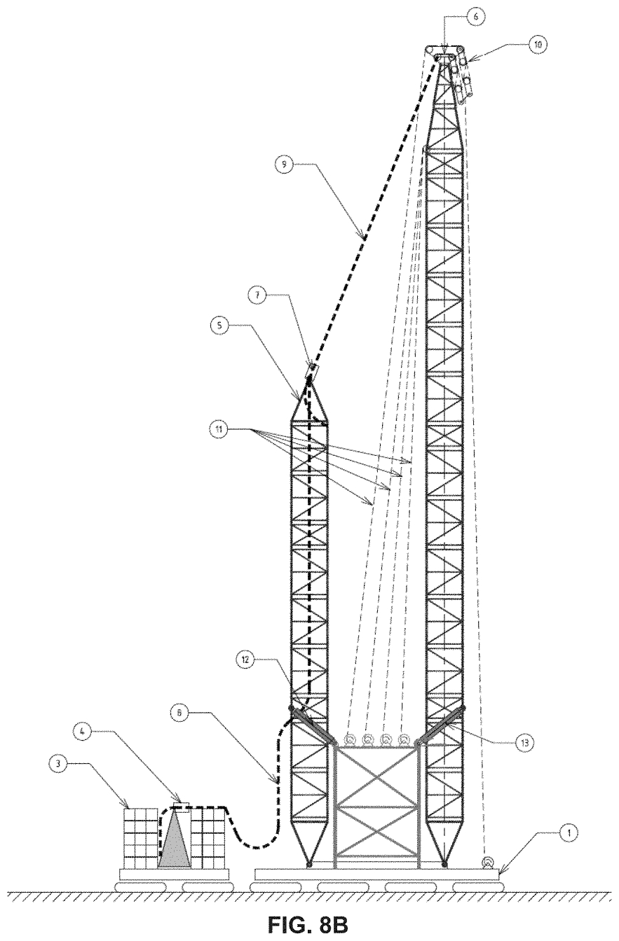

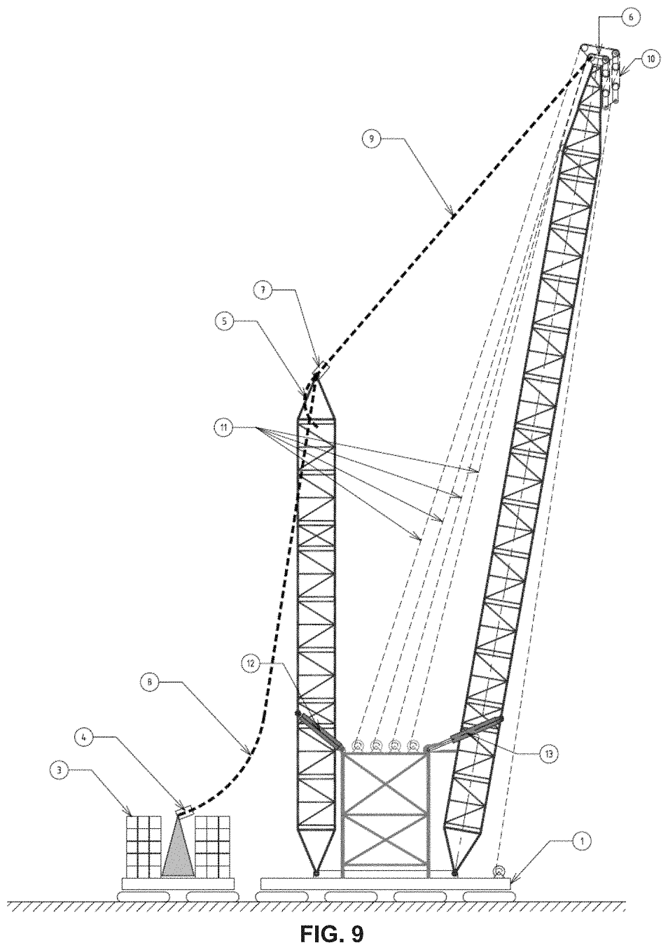

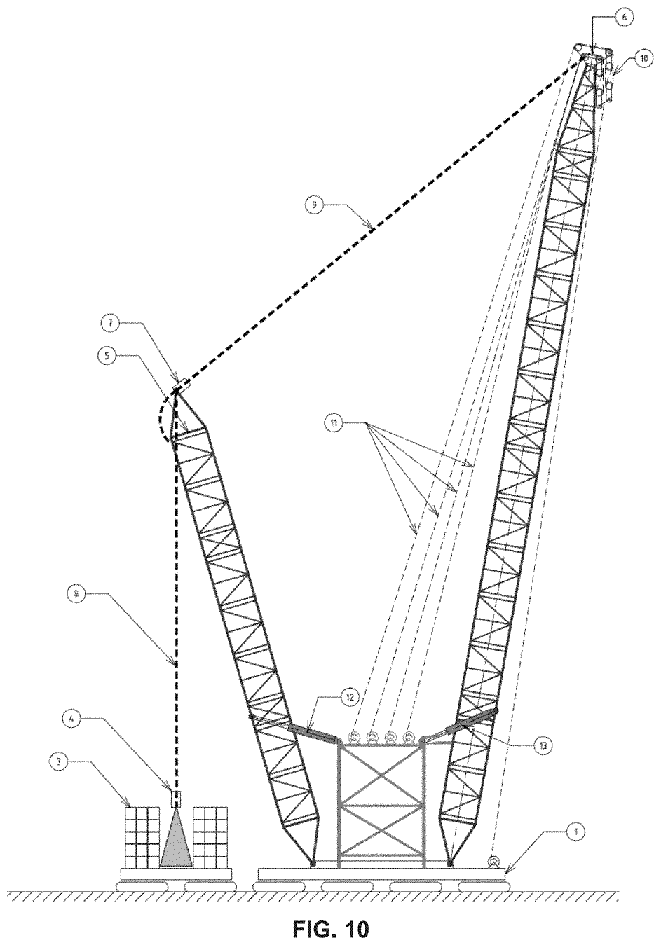

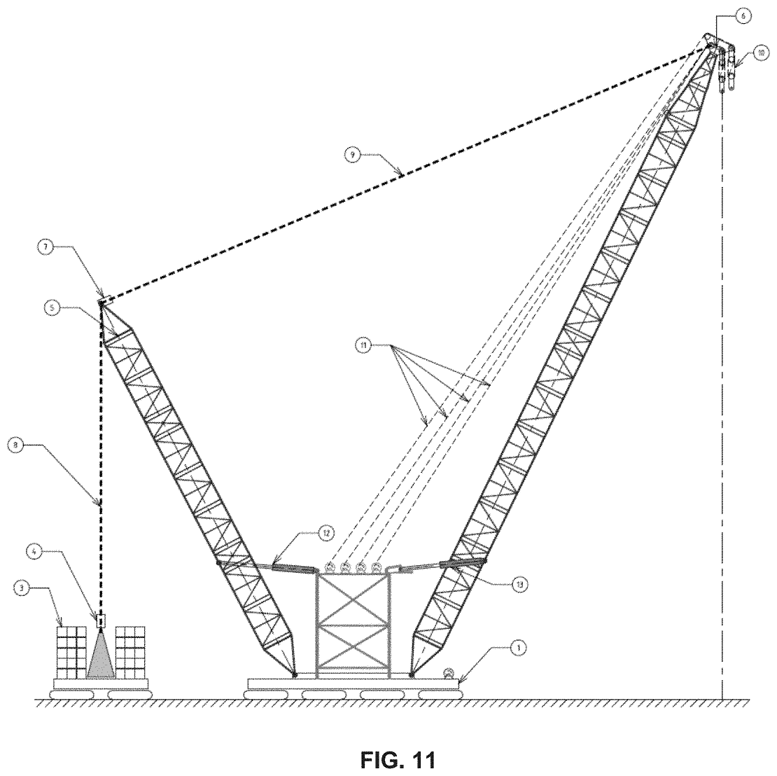

In a first step of positioning the respective parts of the crane FIG. 8A represents tightening of main boom hoist line 9 between back mast 5 and main boom 6. In FIG. 8B it is shown that erection facility or assembly frame 2 has been removed away from the erected crane, so as to provide a clear showing that back mast 5 in main boom 6 are supported only by base frame 1. The following steps of positioning the respective parts of the crane as depicted in FIGS. 9-11, are carried out with erection facility or assembly frame 2 removed from the erected apparatus for hoisting heavy loads. FIG. 9 shows the initial phase of slanting main boom 6. FIG. 10 illustrates the subsequent slanting of back mast 5 and in FIG. 11 it is shown that the erected apparatus for lifting heavy loads has reached its final working position and is ready for use.

It will be clear to the skilled person that dismantling of the apparatus can occur in the reversed order, so that it is not required to show with reference to further figures how to execute the dismantling of the apparatus.

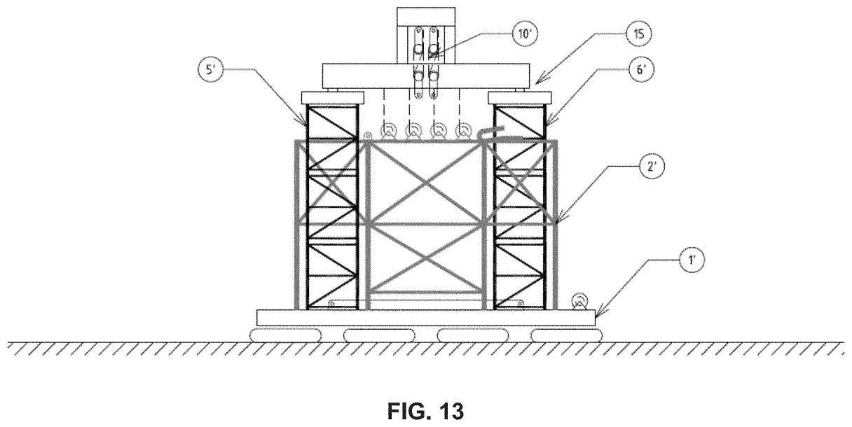

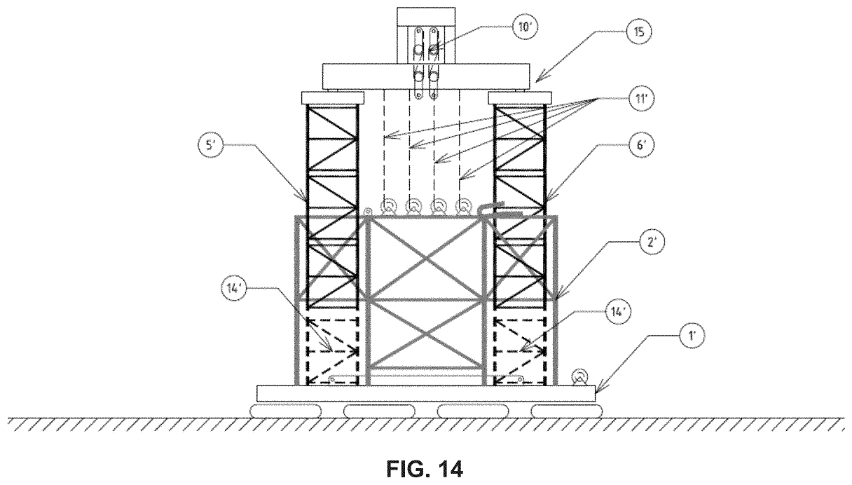

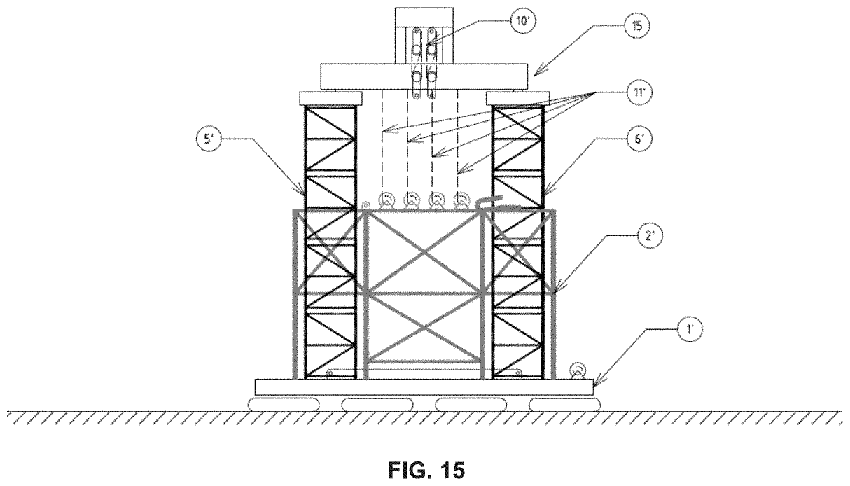

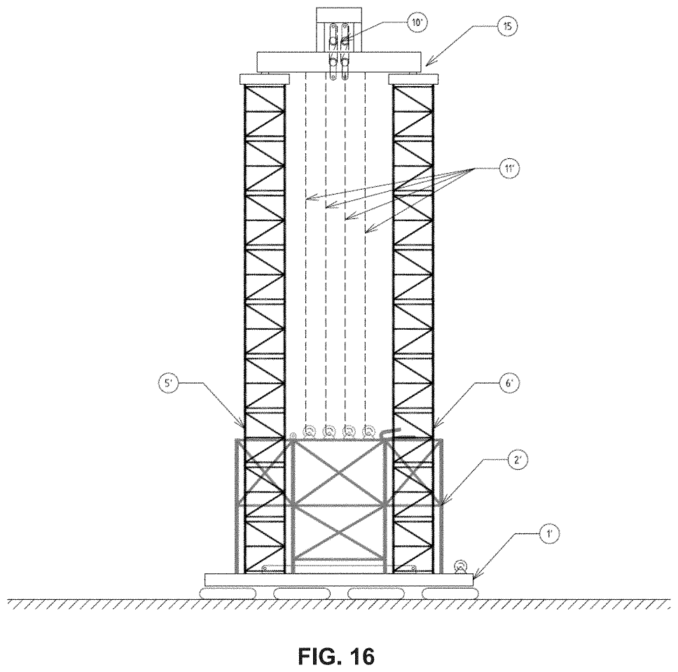

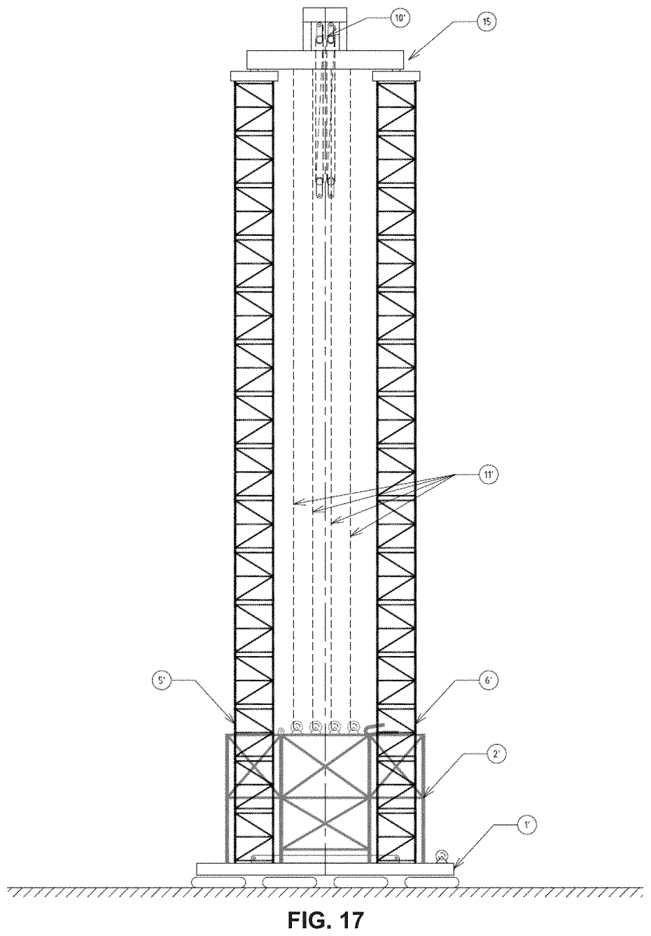

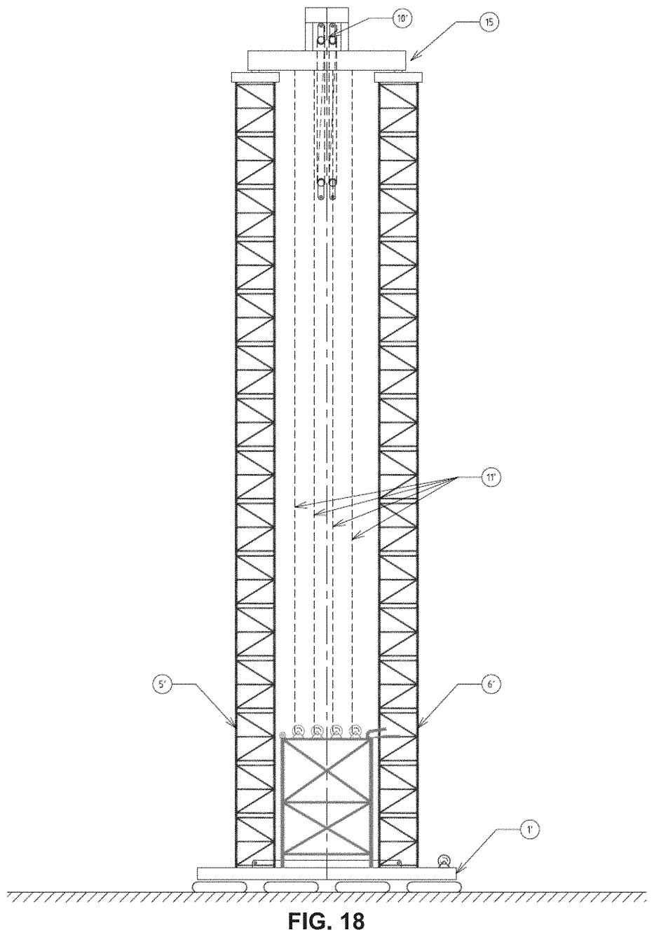

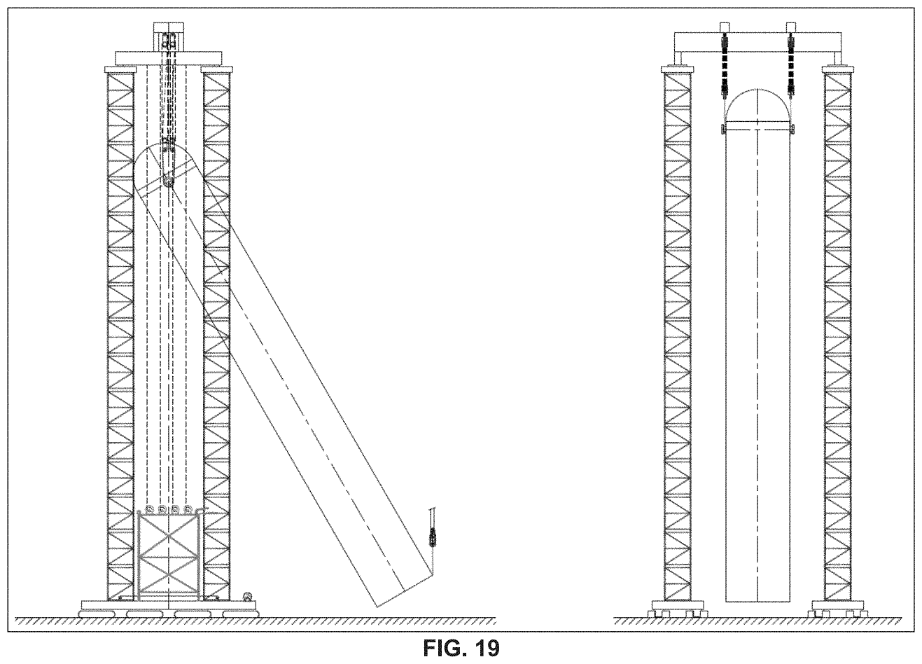

Turning now to FIG. 12 it shows again a starting position of base frame 1′ on which erection facility or assembly frame 2′ is mounted. FIG. 13 shows a subsequent situation wherein the lower parts of two gantry towers or masts 5′, 6′ are placed in assembly frame 2′. In FIG. 14 the lower parts of two gantry towers 5′, 6′ are lifted to make room thereunder in assembly frame 2′ for new mast pieces 14′. In FIG. 15 the newly added mast pieces are connected and assembled to form part of so far assembled masts 5′, 6′, and FIG. 16 represents an intermediate step after a series of such assembly steps have been executed; wherein each step comprises lifting of the so far assembled masts 5′, 6′ and the introduction and mounting of new mast pieces 14′ underneath the so far assembled masts 5′, 6′. In FIG. 17 the two gantry towers 5′, 6′ are shown at their final altitude, wherein they are ready for use. FIG. 18 corresponds to what is shown in FIG. 17, the only difference being that erection facility or assembly frame 2′ has been removed. FIG. 19 finally shows the gantry tower from a different angle while hoisting a heavy load.

Although the invention has been discussed in the foregoing with reference to exemplary embodiments of the apparatus of the invention, the invention is not restricted to these particular embodiments which can be varied in many ways without departing from the invention. The discussed exemplary embodiments shall therefore not be used to construe the appended claims strictly in accordance therewith. On the contrary, the embodiments are merely intended to explain the wording of the appended claims without intent to limit the claims to these exemplary embodiments. The scope of protection of the invention shall therefore be construed in accordance with the appended claims only, wherein a possible ambiguity in the wording of the claims shall be resolved using these exemplary embodiments.

What is claimed is:

1. A system for lifting heavy loads comprising:
an apparatus comprising at least one mast or at least one section thereof, from which a load may be suspended;
a removable erection facility external of said apparatus and disposable on a base, said base disposable on a ground;
said removable erection facility comprising an assembly frame, said assembly frame configured to push-up and to lower said at least one mast or said at least one section thereof;
said removable erection facility equipped to receive, during erection of said apparatus, or to remove, during dismantling of said apparatus, said at least one mast or said at least one section thereof below an assembled portion of said at least one mast or said at least one section thereof, thereby converting said apparatus between a dismantled position and an erected position;
said assembly frame removable away from said apparatus and from said base after erection of said apparatus.

2. The system according to claim 1 wherein said at least one mast or said at least one section thereof comprises as an assembly of mast sections that are mountable to and dismountable from one or more other of said at least one mast or said at least one section thereof in a top to bottom configuration.

3. The system according to claim 1 wherein said at least one mast or said at least one section thereof comprises two masts or two sections thereof.

4. The system according to claim 3 wherein said two masts or said two sections thereof comprise gantry towers.

5. The system according to claim 3 wherein said two masts or said two sections thereof comprise a main boom and a back mast of a crane, and wherein said system further comprises a counter-weight.

6. A method for assembling or disassembling an apparatus for lifting heavy loads, comprising:
providing an apparatus comprising at least one mast or at least one section thereof;
providing an erection facility external of the apparatus, the erection facility disposable on a base, said base disposable on a ground;
providing the erection facility with an assembly frame configured to push up and lower the at least one mast or the at least one section thereof;
supplying to the erection facility, during erection of the apparatus, or removing from the erection facility, during dismantling of the apparatus, the at least one mast or a series of sections of the at least one mast below a top portion of the at least one mast so as to convert the apparatus between a dismantled position and an erected position; and
moving the assembly frame external of the apparatus and the base after erection of the apparatus.

7. The method of claim 6 wherein the at least one mast comprises an assembly of mast sections that are mountable to one or more other of the mast sections in a top to bottom configuration.

8. The method of claim 6 wherein providing an apparatus comprising the at least one mast or the at least one section thereof comprises providing an apparatus with two masts or two sections thereof.

9. The method of claim 8 further comprising arranging the two masts or the two sections thereof as gantry towers.

10. The method of claim 8 further comprising arranging the two masts or the two sections thereof as a main boom and a back mast of a crane, and providing a counter-weight for the main boom and/or the back mast of the crane.
